(19) United States
(12) Patent Application Publication
(10) Pub. No.: US 2011/0252600 A1
(43) Pub. Date: Oct. 20, 2011

(54) HINGE

(75) Inventor: JUNG-BIN CHANG, Tu-Cheng (TW)

(73) Assignee: HON HAI PRECISION INDUSTRY CO., LTD., Tu-Cheng (TW)

(21) Appl. No.: 12/784,516

(22) Filed: May 21, 2010

(30) Foreign Application Priority Data
Apr. 14, 2010 (TW) 99206741

(51) Int. Cl. E05F 1/12; E05D 5/10

(52) U.S. Cl. 16/277; 16/386

(57) ABSTRACT

A hinge includes a fixing member, a shaft non-rotatably fixed to the fixing member, a rotating member, an adjusting member, an elastic assembly, and a fastener. The shaft includes a shaft post, and the fastener fixed to a distal end of the shaft post. The rotating member and the elastic assembly are rotatably sleeved on the shaft post. The rotating member defines a depressed slot. The adjusting member is fixed to the shaft post, and abuts against the rotating member. The adjusting member defines a groove. When the rotating member is rotated relative to the fixing member, the depressed slot can be rotated to align with the groove, or away from the groove.

### BACKGROUND

1. Technical Field

The disclosure relates to a hinge.

2. Description of Related Art

A collapsible device, such as a notebook computer, or a clamshell mobile phone, generally includes a main body hinged to a display.

The hinge includes a shaft sleeve, and a shaft rotatably received in the shaft sleeve. The shaft is in frictional engagement with an inner wall of the shaft sleeve during rotation of the shaft relative to the shaft sleeve. Therefore, the display can stay positioned at any angle with respect to the main body using friction between the shaft and the shaft sleeve. However, when opening or closing the display relative to the main body, the shaft and shaft sleeve have an invariant friction, which requires users to provide extra force to operate the display and occasionally they may inadvertently cause the display to strike to hard against the main body, thus causing damage and may be shorten the life of the device. Therefore, it is inconvenient for users.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a hinge, the hinge includes a rotating member and an adjusting member.

FIG. 2 is an enlarged view of the rotating member and the adjusting member of the hinge of FIG. 1.

FIG. 3 is an assembled, isometric view of the hinge of FIG. 1.

FIG. 4 is a cross-section of FIG. 3, taken along the line IV-IV.

FIG. 5 is similar to FIG. 4, but shows the rotating member rotated relative to the adjusting member at an angle.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

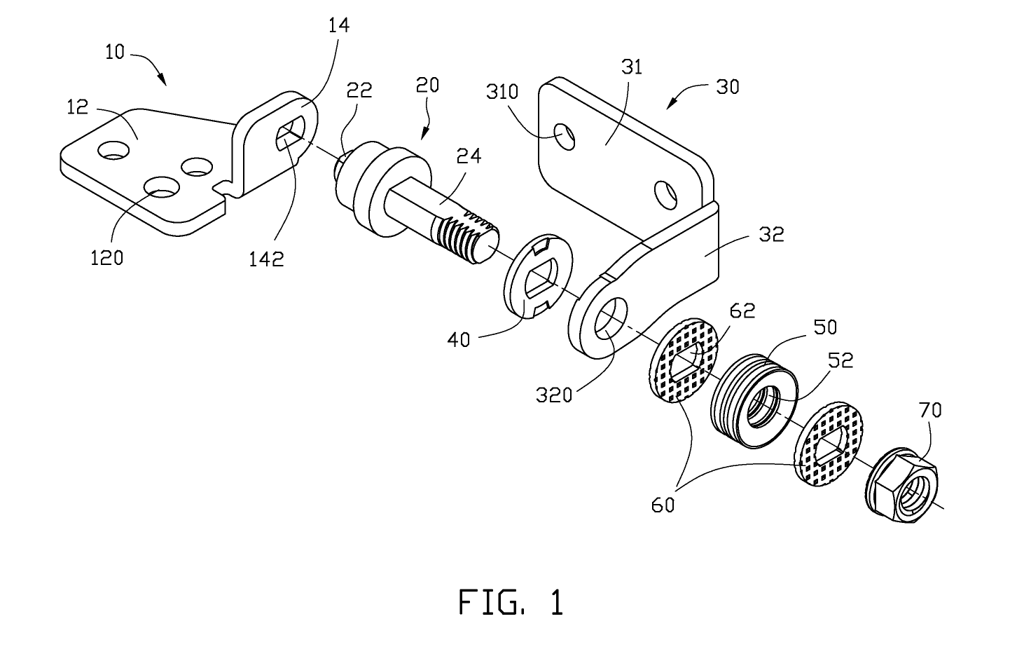

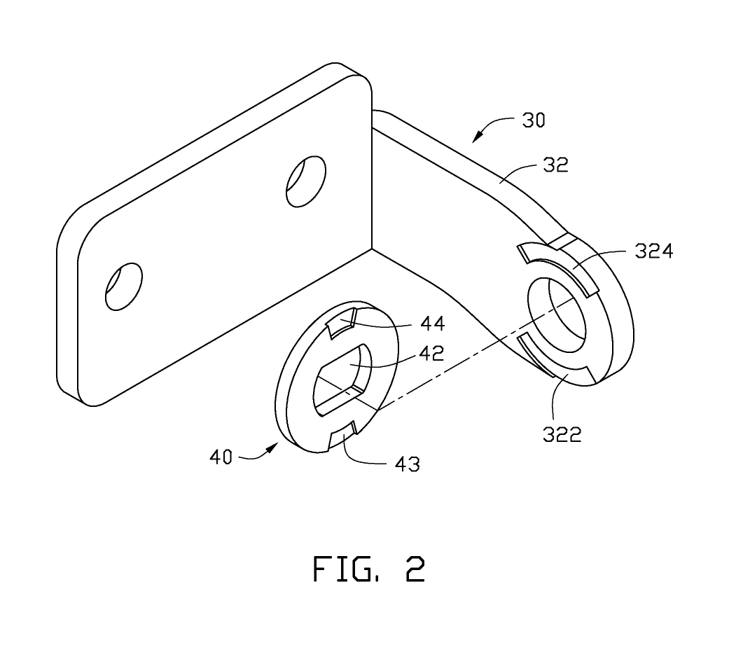

Referring to FIGS. 1 and 2, in an exemplary embodiment, a hinge includes a fixing member 10, a shaft 20, a rotating member 30, an adjusting member 40, an elastic assembly 50, two washers 60 correspondingly situated at opposite ends of the elastic assembly 50, and a fastener 70. In this embodiment, the fastener 70 is a nut.

The fixing member 10 includes a connecting board 12 defining a plurality of fixing holes 120 therein, and a fixing board 14 perpendicularly extending from a side of the connecting board 12. The fixing board 14 defines a substantially double-D shaped matching hole 142.

The shaft 20 includes a fixing portion 22, and a shaft post 24 opposite to the fixing portion 22. The shaft post 24 has a substantially double D-shaped cross-section, and forms a threaded portion (not labeled) on a circumference of a distal end of the shaft post 24, for engaging with the fastener 70. The fixing portion 22 has a substantially double D-shaped cross-section, corresponding to the matching hole 142 of the fixing member 10.

The rotating member 30 is generally L-shaped. The rotating member 30 includes a fixing arm 31 defining a plurality of fixing holes 310 therein, and a pivoting portion 32 extending from an end of the fixing arm 31. The pivoting portion 32 defines a through hole 320, through which the shaft post 24 of the shaft 20 rotatably extends. A side of the pivoting portion 32 facing the adjusting member 40 defines two opposite arc-shaped depressed slots around the through hole 320. In this embodiment, the depressed slots are a first depressed slot 322 and a second depressed slot 324, both adjacent to a circumference of the pivoting portion 32, and are substantially opposite each other across the through hole 320.

The adjusting member 40 defines a substantially double D-shaped mounting hole 42, through which the shaft post 24 of the shaft 20 non-rotatably passes. A side of the adjusting member 40 facing the pivoting member 32 of the rotating member 30 defines two opposite grooves. In this embodiment, the grooves are a first groove 43 and a second groove 44, both adjacent to a circumference of the adjusting member 40, and opposite each other across the mounting hole 42.

The elastic assembly 50 includes a plurality of elastic rings (not labeled) arranged in a line and resisting against each other. Each elastic ring defines a round through hole 52, allowing the shaft post 24 of the shaft 20 to rotatably pass therethrough. The elastic assembly 50 provides elasticity along an axis of the shaft 20, to tighten the adjusting member 40, the washers 60, and the rotating member 30.

Each washer 60 defines a substantially double-D shaped fixing hole 62 in a center of the corresponding washer 60, through which the shaft post 24 of the shaft 20 non-rotatably passes.

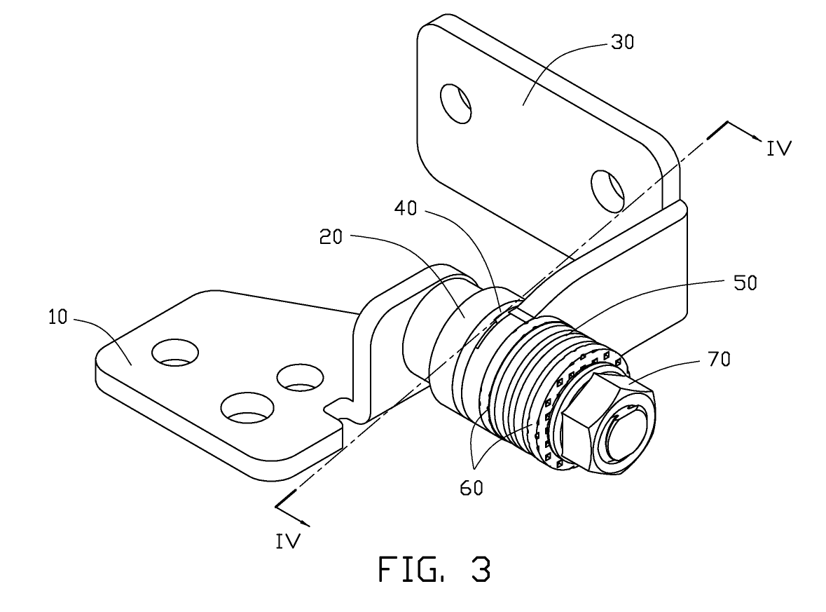

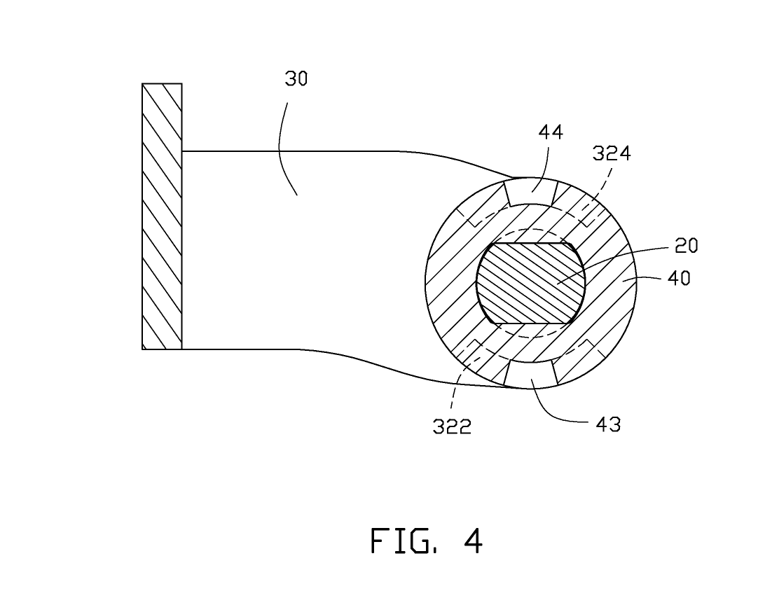

Referring to FIGS. 3, and 4, in assembly, the fixing portion 22 of the shaft 20 is fixedly received in the matching hole 142 of the fixing member 10. Thereby, the shaft 20 is non-rotatably fixed to the fixing member 10. The shaft post 24 of the shaft 20 is extended through the mounting hole 42 of the adjusting member 40, the through hole 320 of the rotating member 30, the fixing hole 62 of one of the washers 60, the through hole 52 of the elastic assembly 50, and the fixing hole 62 of the other washer 60 one by one in that order, with the distal end of the shaft post 24 engaging in the fastener 70 for preventing the rotating member 30, the washers 60, the elastic assembly 50, and the adjusting member 40 from disengaging from the shaft 10. In this state, the adjusting member 40 abuts against the pivoting portion 32 of the rotating member 30, with the first and second grooves 43 and 44 of the adjusting member 40 aligned with the first and second depressed slots 322 and 324 of the rotating member 30. Therefore, the contact are between the adjusting member 40 and the pivoting portion 32 is the largest, so that the friction between the adjusting member 40 and the rotating member 30 is the largest.

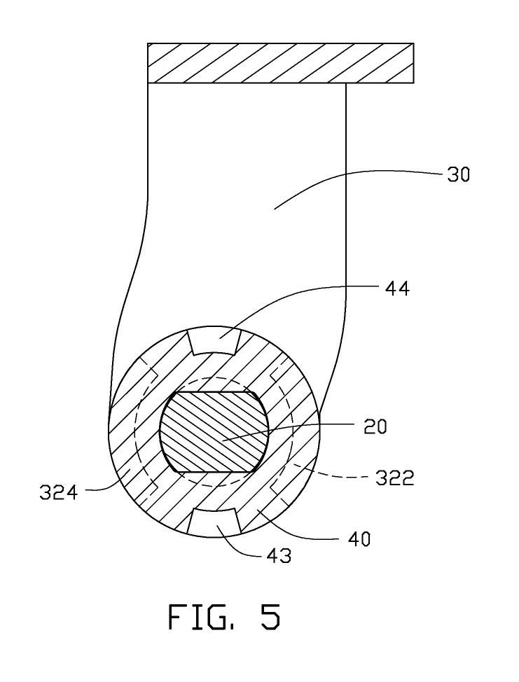

Referring to FIG. 5, in use, the above-mentioned hinge can be utilized in a collapsible device (not shown), such as a notebook computer, that includes a base (not shown) and a cover (not shown) hinged to the base. The rotating member 30 is fixed to the cover with the fixing holes 310. Correspondingly, the fixing member 10 is fixed to the base with the fixing holes 120. During the opening of the cover, the cover is rotated relative to the base, so that the rotating member 30 is rotated relative to the adjusting member 40, with the first and second depressed slots 322 and 324 rotated away from the first and second grooves 43 and 44, correspondingly. When partial portions of the first and second depressed slots 322 and 324 move to connect to the side of the adjusting member 40, the region of friction between the adjusting member 40 and the pivoting portion 32 gradually diminishes. Therefore, the friction between the adjusting member 40 and the rotating member 30 is decreased, so that the cover is easily opened. When the first and second depressed slots 322 and 324 move to completely stagger with the first and second grooves 43 and 44, respectively, friction between the adjusting member 40 and the rotating member 30 is the smallest.

When the cover is closed to the base, the first and second depressed slots 322 and 324 of the rotating member 30 move towards the first and second grooves 43 and 44, correspondingly. During this process, when partial portions of the first and second depressed slots 322 and 324 move to cover on the first and second grooves 43 and 44 of the adjusting member 40, the region of friction between the adjusting member 40 and the pivoting portion 32 gradually becomes larger. Therefore, friction between the adjusting member 40 and the rotating member 30 increases, so that it prevents the cover from closing too fast to strike harshly against the base.

In other embodiments, the adjusting member 40 can define one groove, or more than two grooves. The pivoting portion 32 of the rotating member 30 also can define one depressed slot, or more than two depressed slots.

It is believed that the present embodiments and their advantages will be understood from the foregoing description, and they will be apparent that various changes may be made thereto without departing from the spirit and scope of the description or sacrificing all of their material advantages, the examples hereinbefore described merely being exemplary embodiment.

What is claimed is:

1. A hinge comprising:
a fixing member;
a shaft non-rotatably fixed to the fixing member, the shaft comprising a shaft post;
a rotating member rotatably sleeved on the shaft post, the rotating member defining at least one depressed slot;
an adjusting member non-rotatably fitted about the shaft post, and abutted against the rotating member, the adjusting member defining at least one groove;
an elastic assembly rotatably sleeved on the shaft post, to provide elasticity along an axis of the shaft post to tighten the adjusting member and the rotating member; and
a fastener fixed to a distal end of the shaft post;
wherein when the rotating member is rotated relative to the fixing member, the at least one depressed slot can be rotated to align with the at least one groove, or away from the at least one groove.

2. The hinge of claim 1, wherein the rotating member comprises a pivoting portion defining a through hole, through which the shaft post rotatably extends, the at least one depressed portion is around the through hole.

3. The hinge of claim 2, wherein the adjusting member defines a substantially double-D shaped mounting hole in a center of the adjusting member, for the shaft post non-rotatably extending therethrough.

4. The hinge of claim 1, further comprising two washers fixedly fixed to the shaft post, wherein the washers are located beside opposite ends of the elastic assembly.

5. The hinge of claim 4, wherein each washer defines a substantially double-D shaped fixing hole in a center of the corresponding washer, through which the shaft post non-rotatably passes.

6. A hinge comprising:
a shaft comprising a shaft post;
a rotating member rotatably mounted on the shaft post, the rotating member defining at least one depressed slot; and
an adjusting member non-rotatably mounted on the shaft post, and abutted against the rotating member, the adjusting member defining at least one depressed portion facing the rotating member;
wherein when the adjusting member is rotated relative to the rotating member, the at least one depressed slot can be rotated to align with the at least one groove, or away from the at least one groove such that the friction between the adjusting member and the rotating member is adjusted.

7. The hinge of claim 6, wherein the rotating member comprises a pivoting portion defining a through hole, through which the shaft post rotatably extends, the at least one depressed portion is around the through hole.

8. The hinge of claim 7, wherein the adjusting member defines a substantially double-D shaped mounting hole in a center of the adjusting member, for the shaft post non-rotatably extending therethrough.
